(19) United States
(12) Patent Application Publication
(10) Pub. No.: US 2007/0186384 A1
(43) Pub. Date: Aug. 16, 2007

(54) Wall frame hanging apparatus

(76) Inventors: Joshua Michael Broehl, Worthington, OH (US); Donald James Staufenberg, Dublin, OH (US); Jamison Joseph Float, Westerville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/355,844

(22) Filed: Feb. 16, 2006

(51) Int. Cl. E05D 1/04

(52) U.S. Cl. 16/355; 248/470

(57) ABSTRACT

An apparatus for mounting a hanging frame, such as a picture frame, to a wall. A plate with radially outwardly-facing substantially circular cylindrical surfaces attaches to a wall. A hanger mounts to the frame and has radially inwardly-facing substantially circular cylindrical surfaces seating against the cylindrical surfaces of the plate. The plate has a first lip extending radially outwardly of the cylindrical surfaces of the plate and the hanger has a second lip extending radially outwardly of the cylindrical surfaces of the hanger. The first and second lips seat against one another when the hanger is on the plate for resisting plate movement away from the wall. The lips require the hanger to be lifted off of the plate. The contacting substantially circular cylindrical surfaces facilitate rotation of the hanger relative to the plate.

### BACKGROUND OF THE INVENTION

1. Field of the Invention

This invention relates generally to hangers for wall frames, such as pictures, plaques, easels and other structures that are hung on a wall.

2. Description of the Related Art

It is common to hang wall frames, such as picture frames, against walls by installing a fastener, such as a nail, screw or pin that penetrates a wall, to the wall, and then hanging the downwardly facing edge of a structure attached to the frame on the fastener. Some structures that are conventionally attached to a frame for hanging on the fastener, such as a common nail, include a wire extending across the frame's back or a bar mounted to the frame's back with a downwardly facing edge having a plurality of “saw tooth” notches and metal loops. Another prior art frame-hanging structure is found in U.S. Pat. No. 6,719,260 to Hart.

One disadvantage of conventional structures is that they are difficult for the user to “find” when the back of the frame faces away from the user. Because one cannot see the nail and the hanging structure mounted on the back of the frame when the frame is being hung on the wall, it is difficult to ensure that engagement has occurred. Even after hanging, one cannot usually see whether the frame is correctly mounted on the fastener. If the user assumes that engagement has taken place when it has not, the frame may later drop and break.

Another disadvantage with conventional frame-hanging structures is that the frames often are not level after hanging. This can take place due to incorrect placement of the frame on the fastener, or due to movement of the frame after correct placement. Therefore, the need exists for a frame hanging apparatus that avoids these disadvantages.

### BRIEF SUMMARY OF THE INVENTION

The invention is an apparatus for mounting a hanging frame, such as a picture frame or plaque, to a wall. The apparatus includes a plate with radially outwardly-facing substantially circular cylindrical surfaces. The plate is for attaching to a wall with a fastener. A hanger is mounted to the frame and has radially inwardly-facing substantially circular cylindrical surfaces that seat against the substantially circular cylindrical surfaces of the plate when the hanger is mounted on the plate, such as when the frame is mounted on the wall. The plate has a first lip extending radially outwardly of the substantially circular cylindrical surfaces of the plate and the hanger has a second lip extending radially outwardly of the substantially circular cylindrical surfaces of the hanger. The first and second lips seat against one another when the hanger is on the plate for resisting plate movement away from the wall beyond a predetermined limit.

The lips require the hanger to be lifted off of the plate, and reduce movement of the hanger away from the wall. The contacting substantially circular cylindrical surfaces facilitate rotation of the hanger relative to the plate, in order to adjust the position of the frame, and provide large surface areas to ease mounting of the frame on the wall. A chamfered plate edge adjacent the first lip accommodates a hammer's head, and, due to an angled aperture through the edge, angles the fastener, which can be a nail, into the wall. This angling enhances the holding strength of the fastener.

Advantages of the invention include ease in mounting a frame to a wall due to the hanger having a “target” in the plate that is easier to locate by feel, which is how a picture is hung. Additionally, because the contacting surfaces are substantially circular cylindrical, the frame can easily be rotated to a level position, and will stay in that position due to the substantial friction over the significant surface areas. Other advantages exist, which will become apparent to a person having ordinary skill.

### BRIEF DESCRIPTION OF THE SEVERAL VIEWS OF THE DRAWINGS

FIG. 1 is an exploded view in perspective illustrating an embodiment of the present invention.

FIG. 2 is an exploded view in perspective illustrating the embodiment of FIG. 1 from a different side.

FIG. 3 is a front view illustrating the embodiment of FIG. 1.

FIG. 4 is a side view in section illustrating the embodiment of FIG. 3 through the line A-A of FIG. 3.

FIG. 5 is a view in perspective illustrating a picture frame with a hanger of the present invention mounted thereto.

FIG. 6 is a rear view illustrating the plate of FIG. 1.

FIG. 7 is a front view illustrating the plate of FIG. 1.

FIG. 8 is a side view illustrating the plate of FIG. 6 through the line 8-8.

FIG. 9 is an exploded view in perspective illustrating an embodiment of the present invention.

FIG. 10 is an exploded view in perspective illustrating the embodiment of FIG. 1 from a different side.

FIG. 11 is a rear view in perspective illustrating a frame with a hanger mounted thereto.

FIG. 12 is a side view in section illustrating the frame of FIG. 11 through the line 12-12.

FIG. 13 is an exploded view in perspective illustrating an embodiment of the present invention.

FIG. 14 is an exploded view in perspective illustrating the embodiment of FIG. 1 from a different side.

FIG. 15 is a side view in section illustrating the frame of FIG. 16 through the line 15-15.

FIG. 16 is a rear view in perspective illustrating a frame with a hanger mounted thereto.

FIG. 17 is a front view illustrating an alternative plate.

FIG. 18 is a view in perspective illustrating the plate of FIG. 17.

FIG. 19 is a side view illustrating the plate of FIG. 17 through the line 19-19.

FIG. 20 is a side view illustrating the plate of FIG. 17.

FIG. 21 is a front view illustrating a hanger.

FIG. 22 is a rear view illustrating the hanger of FIG. 21.

FIG. 23 is a view in perspective illustrating the hanger of FIG. 21.

FIG. 24 is a side view illustrating the hanger of FIG. 21.

FIG. 25 is a schematic view of an alternative embodiment of the present invention.

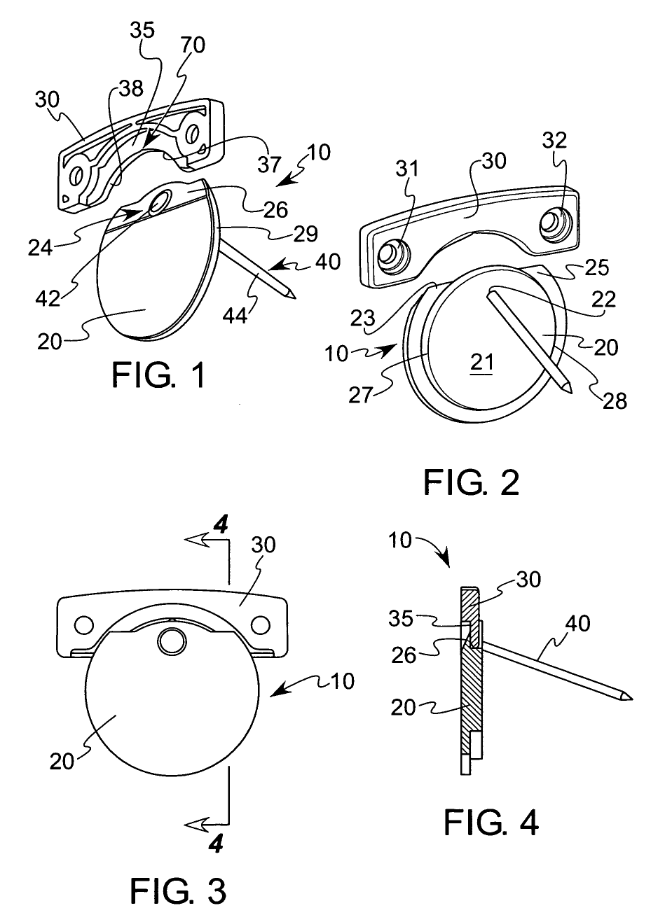

FIGS. 1A-1G are perspective, front, rear, side, top, bottom and side views, respectively illustrating a new, original and ornamental design for a plate for a hanging frame.

FIGS. 2A-2G are perspective, front, rear, side, top, bottom and side views, respectively illustrating a new, original and ornamental design for a plate for a hanging frame.

FIGS. 3A-3G are perspective, front, rear, side, top, bottom and side views, respectively illustrating a new, original and ornamental design for a plate for a hanging frame.

FIGS. 4A-4G are perspective, front, rear, side, top, bottom and side views, respectively illustrating a new, original and ornamental design for a plate for a hanging frame.

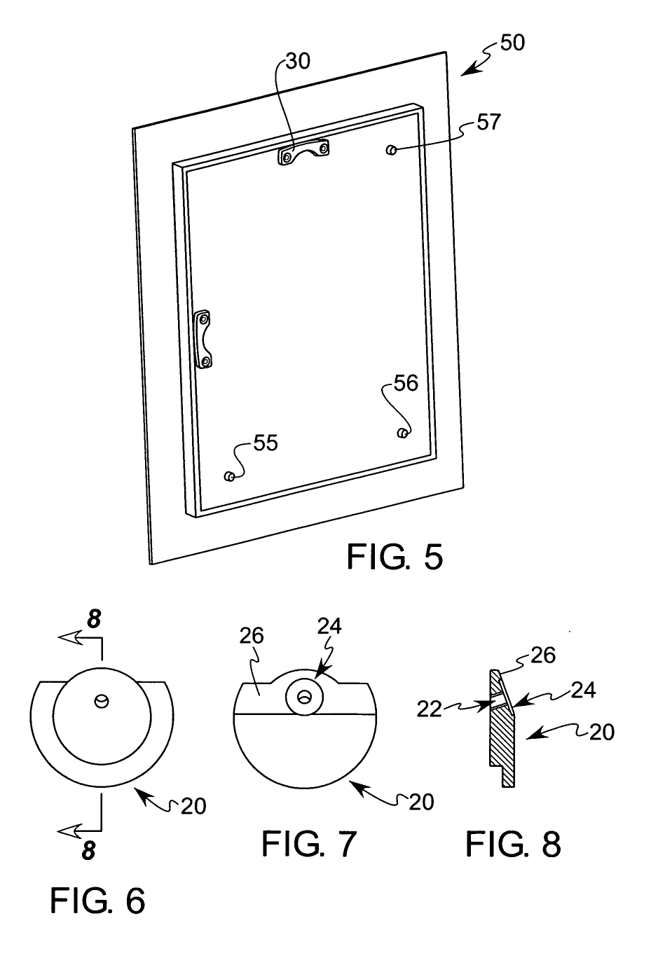

FIGS. 5A-5G are perspective, front, rear, side, top, bottom and side views, respectively illustrating a new, original and ornamental design for a plate for a hanging frame.

FIGS. 6A-6G are perspective, front, rear, side, top, bottom and side views, respectively illustrating a new, original and ornamental design for a plate for a hanging frame.

FIGS. 7A-7G are perspective, front, rear, side, top, bottom and side views, respectively illustrating a new, original and ornamental design for a plate for a hanging frame.

FIGS. 8A-8G are perspective, front, rear, side, top, bottom and side views, respectively illustrating a new, original and ornamental design for a plate for a hanging frame.

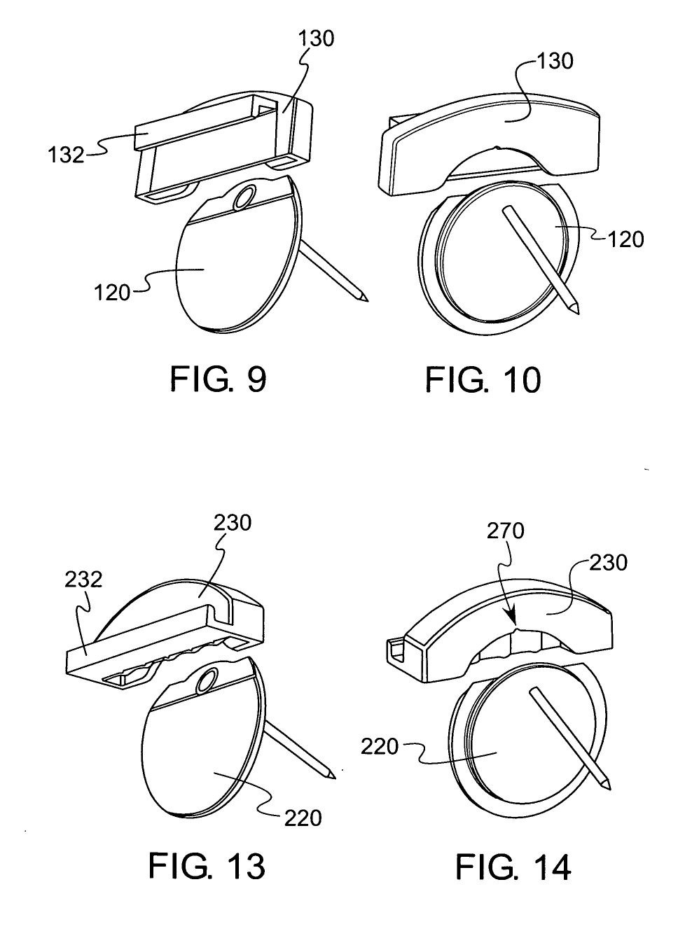

FIGS. 9A-9G are perspective, front, rear, side, top, bottom and side views, respectively illustrating a new, original and ornamental design for a plate for a hanging frame.

FIGS. 10A-10G are perspective, front, rear, side, top, bottom and side views, respectively illustrating a new, original and ornamental design for a plate for a hanging frame.

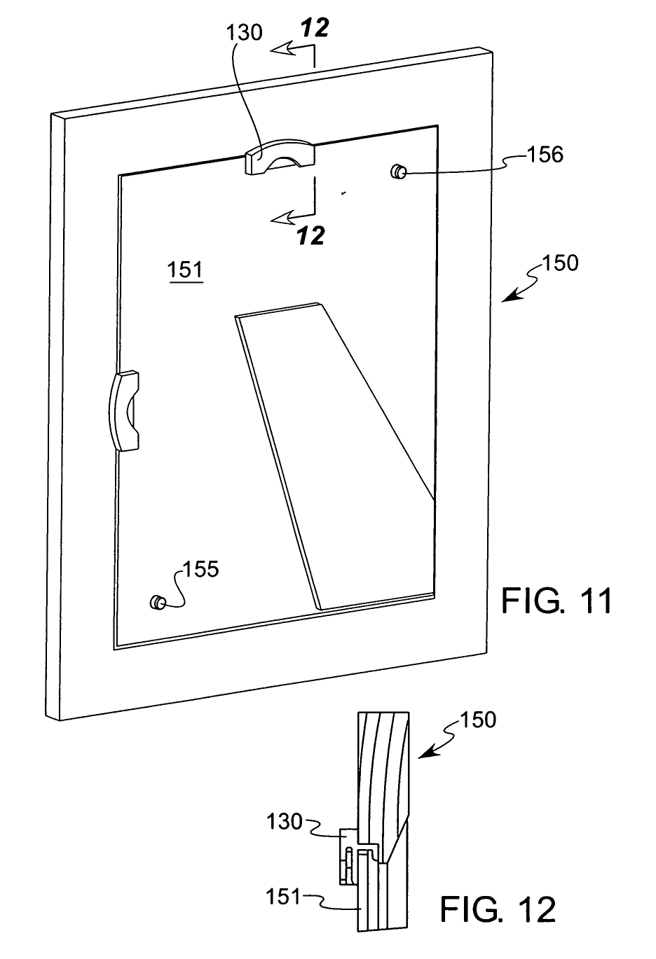

FIGS. 11A-11G are perspective, front, rear, side, top, bottom and side views, respectively illustrating a new, original and ornamental design for a plate for a hanging frame.

FIGS. 12A-12G are perspective, front, rear, side, top, bottom and side views, respectively illustrating a new, original and ornamental design for a plate for a hanging frame.

FIGS. 13A-13G are perspective, front, rear, side, top, bottom and side views, respectively illustrating a new, original and ornamental design for a plate for a hanging frame.

FIGS. 14A-14G are perspective, front, rear, side, top, bottom and side views, respectively illustrating a new, original and ornamental design for a plate for a hanging frame.

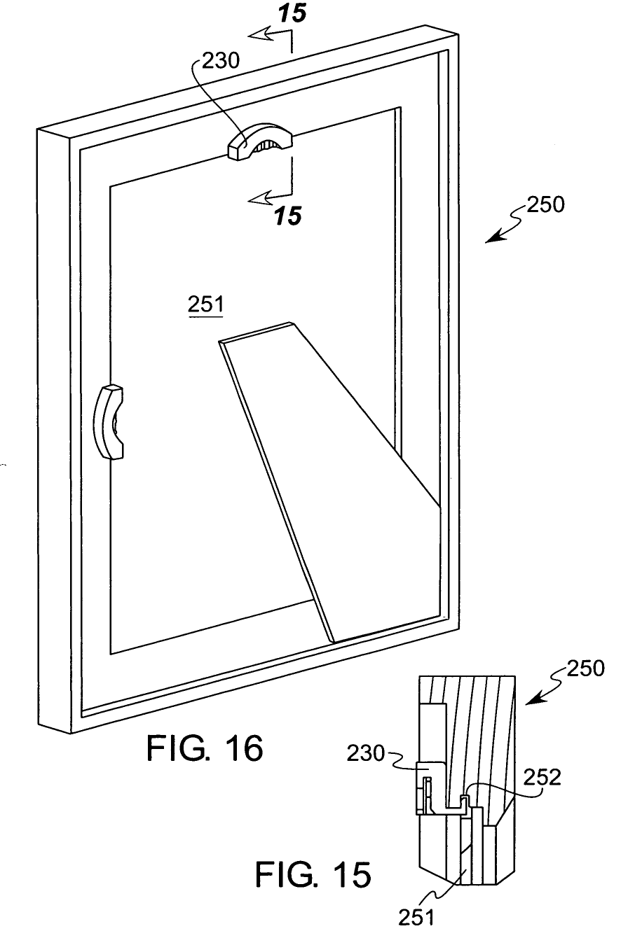

FIGS. 15A-15G are perspective, front, rear, side, top, bottom and side views, respectively illustrating a new, original and ornamental design for a plate for a hanging frame.

FIGS. 16A-16G are perspective, front, rear, side, top, bottom and side views, respectively illustrating a new, original and ornamental design for a plate for a hanging frame.

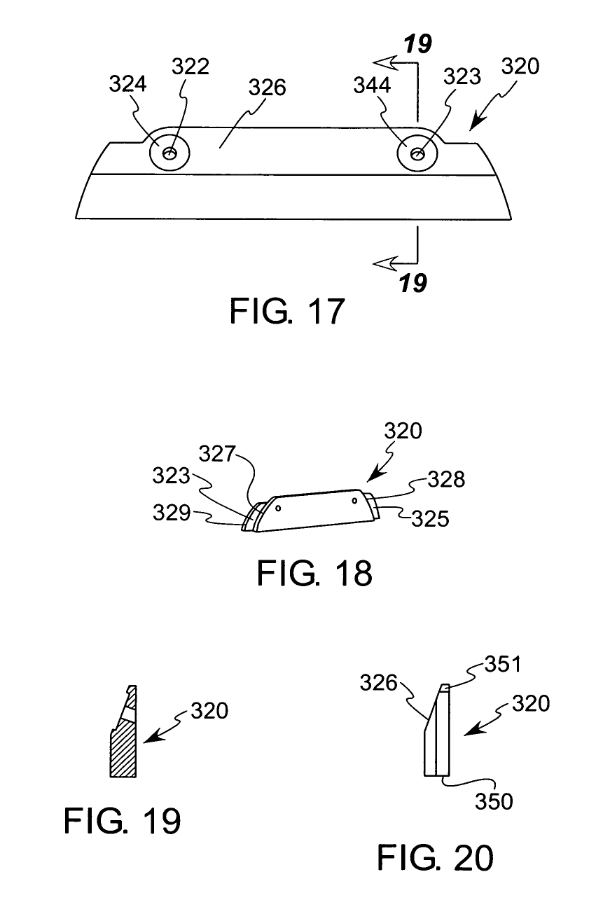

FIGS. 17A-17G are perspective, front, rear, side, top, bottom and side views, respectively illustrating a new, original and ornamental design for a plate for a hanging frame.

FIGS. 18A-18G are perspective, front, rear, side, top, bottom and side views, respectively illustrating a new, original and ornamental design for a plate for a hanging frame.

FIGS. 19A-19G are perspective, front, rear, side, top, bottom and side views, respectively illustrating a new, original and ornamental design for a plate for a hanging frame.

FIGS. 20A-20G are perspective, front, rear, side, top, bottom and side views, respectively illustrating a new, original and ornamental design for a plate for a hanging frame.

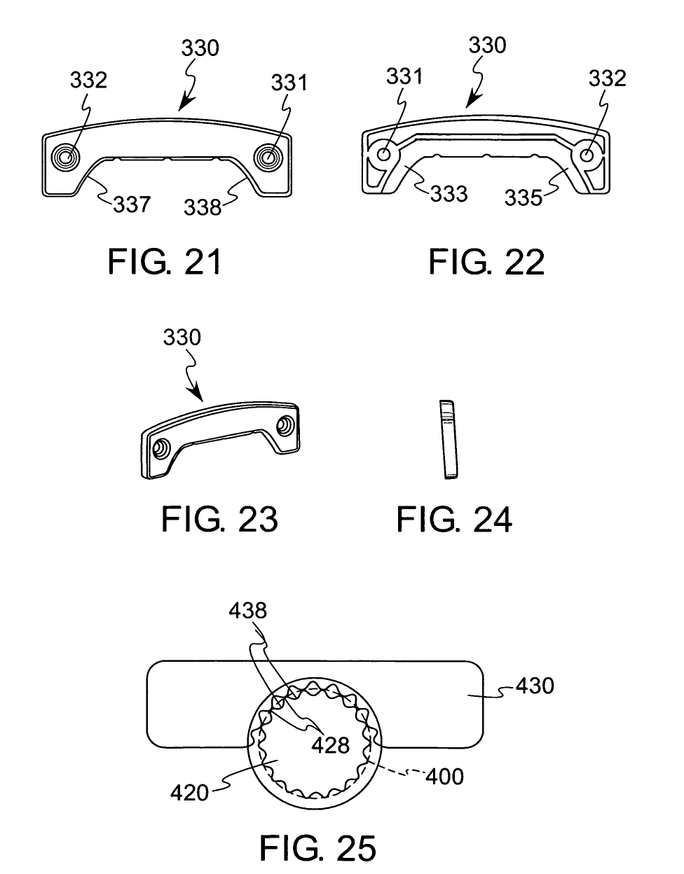

FIGS. 21A-21G are perspective, front, rear, side, top, bottom and side views, respectively illustrating a new, original and ornamental design for a plate for a hanging frame.

FIGS. 22A-22G are perspective, front, rear, side, top, bottom and side views, respectively illustrating a new, original and ornamental design for a plate for a hanging frame.

In describing the preferred embodiment of the invention which is illustrated in the drawings, specific terminology will be resorted to for the sake of clarity. However, it is not intended that the invention be limited to the specific term so selected, and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

The preferred embodiment of the present invention is illustrated in FIG. 1, which shows the hanging apparatus 10 having a plate 20, a hanger 30 and a fastener, such as the nail 40. The plate 20 is preferably a flat sheet of relatively strong material, such as plastic, metal, wood or a composite material, and has an aperture 22 near its upper edge, as shown in FIGS. 1 and 2. The nail 40 has a shaft 44 that extends through the aperture 22 and into a wall, as described further below. The nail head 42 seats in a recess 24 formed on one side of the aperture 22, causing the top of the nail head to lie essentially flush with, or slightly above, the plane of the surface in which the aperture 22 is formed.

The plate 20 has a chamfered edge 26 formed on its upper end as shown in FIGS. 1, 7 and 8. This edge 26 is angled relative to the parallel, major faces of the plate 20 by approximately 20 degrees, although the angle can vary between a few degrees and almost 90 degrees. The aperture 22 and the recess 24 are formed through the edge 26, and the axis of the aperture 22 is perpendicular to the plane of the edge 26 so that the nail head 42 remains parallel to the plane of the edge 26 when the nail is driven through the aperture 22.

The angled aperture 22 holds the nail 40 at an angle relative to the wall that is essentially the same as the angle that the edge 26 makes relative to the major faces of the plate 20. This downwardly angling secures the nail in the wall with much more holding power than if the nail were perpendicular to the plate 20, because as weight is placed on the plate 20, the nail is pulled in a direction that has a component of force along its length, rather than perpendicular to its shaft. The angled nail also reduces rotation of the plate once the nail is hammered into the wall.

The chamfered edge 26 permits the nail to be driven with its head flush with the edge 26 while the installer strikes the nail with a hammer at a natural angle. The chamfer reduces the likelihood that a strike on the plate with the hammer will fracture or destroy the plate.

Locating the aperture 22 at one edge of the plate 20 permits the user to hold the nail during hammering into the wall by simply gripping the opposite edge of the plate 20. This avoids the need to grip the nail head 42 or shaft, thereby reducing the likelihood of injury if the nail is missed.

Radially outwardly facing substantially circular cylindrical surfaces 27 and 28 are formed radially inwardly of the peripheral edge 29 of the plate 20 to form a rim that will seat against complementary surfaces on the hanger 30. The surfaces 27 and 28 extend circumferentially around the plate 20 from the thinnest edge of the plate 20 to the opposite edge of the plate. As explained below in relation to FIGS. 17 and 21, the substantially circular, cylindrical surfaces could extend only partially around the plate. The surfaces 27 and 28 are preferably smooth, but can be formed by a plurality of radially outwardly extending tips positioned circumferentially around a portion of the plate 20 so long as the tips are aligned substantially along a circle (as shown in FIG. 25).

The lips 23 and 25 extend circumferentially from the intersection of the chamfered edge 26 and the surfaces 27 and 28 downwardly toward the opposite edge of the plate 20. The lips 23 and 25 extend radially outwardly from the surfaces 27 and 28 to the peripheral edge 29. As will be discussed further below, the lips 23 and 25 prevent the plate 20 from moving axially relative to the hanger 30, and could extend only partially around the plate 20 circumferentially, because it is the portions of the lips 23 and 25 nearest the edge 26 that contact, and therefore cooperate with, the hanger 30.

The hanger 30 is a relatively strong material, such as plastic, metal, wood or a composite material, and has a pair of apertures 31 and 32 through which fasteners, such as screws, extend into the frame that is to be hung. One example of the positioning of the hanger 30 on a frame is shown in FIG. 5. Of course, the hanger can be placed in other locations on frames. Additionally, other fasteners can be used to mount the hanger 30 to a frame, as will be understood by the person having ordinary skill, and these include, but are not limited to, nails, staples, adhesives, frictional engagement, etc. The frames with which the present invention works include, but are not limited to, picture frames, plaques, easels and any other rigid, substantially planar structure that is to be displayed from a wall.

The hanger 30 has radially inwardly-facing substantially circular cylindrical surfaces 37 and 38, forming a shoulder for seating against the surfaces 27 and 28, respectively, of the plate 20. The lip 35 is formed by the portion of the hanger 30 that extends radially outwardly of the surfaces 37 and 38. The lip 35 seats against the lips 23 and 25 of the plate 20 as described below.

The invention can be utilized in the following manner. The plate 20 is attached to a wall by placing the plate 20 in the desired position on the wall, preferably with the aperture 22 positioned at the top. The rear surface 21 (see FIG. 2) is placed against the wall, the nail 40 is inserted into the aperture 22 and the nail is hammered into the wall while the user grips the plate at the edge opposite the edge 26. Once the nail 40 is installed with its head seated against the recess 24, the plate 20 is securely fixed to the wall.

The hanger 30, if it is not already mounted to a frame, such as in the manner shown in FIG. 5, is mounted to the back of a frame, preferably near the top edge and preferably centered. The frame is then placed with its back to the wall on which the plate 20 is mounted, the hanger 30 is placed as close to directly above the plate 20 as possible, and then the frame is slid downwardly until the plate 20 is inserted into the hanger 30 with the lips 23 and 25 of the plate 20 extending behind the lip 35 of the hanger 30 as shown in FIGS. 3 and 4.

During hanging, there is a positive and palpable engagement of the hanger with the plate, and this engagement remains until the frame is deliberately lifted from the plate. If, during installation, the cylindrical surfaces 37 and 38 on the hanger 30 are not perfectly aligned with the cylindrical surfaces 27 and 28 on the plate 20, downward movement of the frame will cause the cylindrical surfaces of one structure to slide along and down the cylindrical surfaces of the other, thereby aligning the hanger on the plate. This self-aligning feature causes the invention to make hanging a frame much easier than with the prior art. This self-alignment could be aided by additional chamfered surfaces to create a funneling effect, but need not.

When the frame is in the mounted position, the surfaces 37 and 38 rest upon the surfaces 27 and 28, respectively. Because the contacting regions of both pairs of surfaces are substantially circular cylindrical, there is contact along the interfacing surfaces, which are along at least a portion of a circle, thereby permitting rotation of the hanger 30 relative to the plate 20 by the surfaces 37 and 38 sliding against the surfaces 27 and 28. Because the surfaces 27, 28, 37 and 38 are all substantially circular cylinders, they slide relative to one another without disrupting the position of the frame 50 on the wall. Furthermore, during rotation of the frame 50, the contacting surfaces remain in contact. Thus, if the frame is not level initially, it can simply be rotated around the plate's surfaces until it is. Even if the plate 20 is installed slightly cocked to one side, the hanger 30 can be rotated a significant amount, in a range of 30 to 60 degrees, until the frame is level. This is due to the substantially circular cylindrical surfaces that rest against one another. It should be noted that the large surface areas in contact with one another create substantial friction across the interface, thereby resisting any rotational movement of the hanger relative to the plate that can easily be overcome by a person's hand, but is not easily overcome by the force of gravity. This permits the frame to be hung slightly misaligned from the plate, if desired, or if the plate is installed rotated from its ideal orientation.

When the surfaces 37 and 38 rest upon the surfaces 27 and 28, the lips 23 and 25 seat against, or are positioned adjacent to, the lip 35. This positioning of the lips prevents axial movement (axial movement is in the direction substantially perpendicular to the wall) of the hanger from unseating the hanger 30 from the plate 20. Thus, the lips 23, 25 and 35 require the frame to be raised before the hanger 30 can come unhooked from the plate 20.

The invention can be embodied in many different structures. Some other embodiments of the invention are shown in FIGS. 9 through 16. FIGS. 9 and 10 show a plate 120 that is essentially identical to the plate 20. The hanger 130 is substantially identical to the hanger 30, except that it is attached to a frame not by fasteners extending through apertures, but by a finger 132. The finger 132 extends between the frame 150 and the backer board 151, as shown in FIGS. 11 and 12, and is held in place by frictional engagement and by the backer board 151 blocking its exit when the backer board 151 is mounted in the frame 150. The backer board 151 may have to be notched in order to accommodate the thickness of the hanger 130, and the hanger 130 can be removed easily from the frame when not being used.

FIGS. 13 and 14 show a plate 220, which is essentially identical to the plate 20. The hanger 230 is substantially identical to the hanger 30, except that the hanger 230 is attached to a frame not by fasteners extending through apertures, but by a finger 232. The finger 232 extends into a slot 252 formed in the frame 250 adjacent to the backer board 251, as shown in FIGS. 15 and 16, in the manner of a hook. This attachment makes the hanger 230 easily removed.

There are many other possible structures that can attach a hanger to a frame, and they are too numerous to list. However, the person having ordinary skill is aware of these structures, including forming the hanger, or its functional components, integral with a frame.

The plate 20 and hanger 30 are designed without a specific size requirement. For example, the plate 20 can be one inch in diameter, and the hanger 30 can be approximately 1.5 inches long. Alternatively, the plate 20 can be three inches in diameter, and the hanger 30 can be 4 inches long. However, in such a large device, a large portion of the surfaces that cooperate are not necessary, resulting in a large amount of material being wasted if the plate and hanger are made as shown in FIG. 1. As an alternative, a larger plate and hanger combination can have the configuration shown in FIGS. 17 through 24. The plate 320 illustrated has a chamfered edge 326 with apertures 322 and 323 through which nails or other fasteners can be extended to attach to a wall. The recesses 324 and 344 receive nail or screw heads, and the chamfered edge 326 accommodates a hammer head just like the chamfered edge 26 on the plate 20. The use of two apertures permits a stronger attachment to the wall for this larger plate 320.

The radially outwardly facing substantially circular cylindrical surfaces 327 and 328 are formed radially inwardly of the peripheral edge 329 of the plate 320. The surfaces 327 and 328 extend circumferentially around the plate 320 from the thinnest edge 351 of the plate 320 to the lower, flat edge 350 of the plate (see FIG. 20).

The lips 323 and 325 are formed at the intersection of the thinnest edge 351 and the surfaces 327 and 328, and extend circumferentially downwardly to the opposite edge 350 of the plate. The lips 323 and 325 also extend radially outwardly from the surfaces 327 and 328 to the peripheral edge 329. As with the lips in the embodiment illustrated in FIGS. 1-2, the lips 323 and 325 prevent the plate 320 from moving axially relative to the hanger 330.

The hanger 330, shown in FIGS. 21-24, has a pair of apertures 331 and 332 through which fasteners, such as screws, extend into the frame that is to be hung. Of course, other fasteners can be used to mount the hanger 330 to a frame, as will be understood by the person having ordinary skill. The hanger has radially inwardly-facing substantially circular cylindrical surfaces 337 and 338 for seating against the surfaces 327 and 328, respectively, of the plate 320. The lips 333 and 335 are formed by the portion of the hanger 330 that extends radially outwardly of the surfaces 337 and 338. The lips 333 and 335 seat against the lips 323 and 325 of the plate 320 when the hanger 330 is mounted over the plate 320.

When the frame is mounted to a wall, the surfaces 337 and 338 rest upon the surfaces 327 and 328, respectively. Because the contacting regions of both pairs of surfaces are substantially circular cylindrical, there is contiguous contact along at least a portion of a circle, thereby permitting rotation of the hanger 330 relative to the plate 320 by the surfaces 337 and 338 sliding against the surfaces 327 and 328. This is the same as with the plate 20 and hanger 30, even though the surfaces 327 and 328 of the plate 330 are not connected, because it is the position of these cylindrical surfaces and their cooperation with the complementary surfaces 337 and 338 of the hanger 330 that is critical for the invention. Because the surfaces that contact one another are substantially circular cylindrical, rotation of the hanger 330 relative to the plate 320 can occur.

When the surfaces 337 and 338 rest upon the surfaces 327 and 328, the lips 323 and 325 seat against, or are positioned adjacent to, the lips 333 and 335. This positioning of the lips prevents axial movement of the hanger from unseating the hanger 330 from the plate 320 as in the embodiment of FIG. 1.

It is preferred that the thickness of the hanger be no greater than that necessary so that the back surface of the frame can rest against the wall when installed, as in the embodiment shown in FIG. 16. However, many frames do not have a cavity or other structure that can accommodate the hanger without the hanger protruding somewhat from the back of the frame. In such instances, a single hanger could cause the frame to hang non-parallel to the wall. This is a less desirable orientation than any other, and therefore bumpers are used to make the frame parallel to the wall. These bumpers have a thickness similar to the hanger used in association with the bumpers. For example, the bumpers 55, 56 and 57 are installed on the rear of the frame 50 shown in FIG. 5 so that the frame 50 rests parallel to the wall upon which it is mounted, even though the frame is not resting with its back seated against the wall. Additionally, bumpers 155 and 156 are installed on the back of the frame 150 shown in FIG. 11 to accomplish the same result. The bumpers can be different thicknesses to accommodate easels on the backs of picture and other frames.

As noted briefly above, the cylindrical surfaces that seat against one another in order to enhance installation of the hanger on the plate, in addition to rotation of the hanger relative to the plate, can be raised tips instead of a smooth surface. For example, as illustrated in FIG. 25, the hanger 430 is mounted on the plate 420 when the raised tips 438 of the hanger 430 rest upon the raised tips 428 of the plate 420. This embodiment functions similarly to the embodiments described above, because the tips 438 and 428 are aligned along a circle 400, thereby creating an effective cylindrical surface that operates under the same principle as the cylindrical surfaces in the embodiment of FIGS. 1 and 2.

Another feature of the invention is the formation of a small indentation, such as the indentations 70 in FIGS. 1 and 270 in FIG. 14, at the middle of the curved arch of the hanger. This indentation aids in use of the hanger without the plate on a conventional nail. The indentation centers the nail on the hanger.

While certain preferred embodiments of the present invention have been disclosed in detail, it is to be understood that various modifications may be adopted without departing from the spirit of the invention or scope of the following claims.

1. An apparatus for mounting a hanging frame to a wall, the apparatus comprising:
(a) a plate having radially outwardly-facing substantially circular cylindrical surfaces;
(b) a fastener for mounting the plate to the wall;
(c) a hanger mounted to the frame, the hanger having radially inwardly-facing substantially circular cylindrical surfaces for seating against the substantially circular cylindrical surfaces of the plate;
(d) a first lip on the plate extending radially outwardly of the substantially circular cylindrical surfaces of the plate; and
(e) a second lip on the hanger extending radially outwardly of the substantially circular cylindrical surfaces of the hanger for seating against the first lip to resist plate movement beyond a predetermined limit.

2. The apparatus in accordance with claim 1, further comprising a chamfered plate edge adjacent the first lip.

3. The apparatus in accordance with claim 2, further comprising an aperture formed through the chamfered plate edge for extending said fastener through.

4. The apparatus in accordance with claim 2, wherein the plate's substantially circular cylindrical surfaces further comprise a substantially circular cylindrical rim extending circumferentially around at least a portion of the plate that is adjacent the chamfered plate edge.

5. The apparatus in accordance with claim 4, wherein the hanger's substantially circular cylindrical surfaces further comprise a substantially circular cylindrical curved shoulder extending circumferentially around at least a portion of the hanger that is adjacent the second lip.

6. The apparatus in accordance with claim 2, wherein the plate's substantially circular cylindrical surfaces further comprise a plurality of radially outwardly extending tips positioned circumferentially around at least a portion of the plate that is adjacent the chamfered plate edge, which tips are aligned substantially along a circle.

7. The apparatus in accordance with claim 6, wherein the hanger's substantially circular cylindrical surfaces further comprise a plurality of radially inwardly extending tips positioned circumferentially around at least a portion of the hanger that is adjacent the second lip, which tips are aligned substantially along a circle.
